(19) United States
(12) Patent Application Publication
(10) Pub. No.: US 2005/0071742 A1
(43) Pub. Date: Mar. 31, 2005

(54) Method and system for estimating the symmetry in a document

(75) Inventor: Helen Balinsky, Cyncoed (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/897,034

(22) Filed: Jul. 23, 2004

(30) Foreign Application Priority Data
Jul. 24, 2003 (GB) 0317300.2

(51) Int. Cl. G06F 15/00

(52) U.S. Cl. 715/500

(57) ABSTRACT

A method for estimating the symmetry present in a page or part of a page of a document comprising defining a set of co-ordinates of features of the content of the document using a co-ordinate system: one axis of which is aligned with an axes about which the symmetry is to be estimated and the other orthogonal to this; mapping the co-ordinates into complex co-ordinates in a complex plane and determining how far the content is from the nearest symmetrical layout.

This invention relates to a method and system for estimating the degree of symmetry present in a page or a part of a page of a document. It is especially but not exclusively suited to the post generation analysis of automatically produced documents.

A reader decides within seconds of picking up a document—such as a printed page of text or graphics—whether or not to continue reading. For example, where an important message is on a page, an eye-catching headline can attract a reader enough to read the article below. Similarly for a catalogue or advertisement, or indeed any one of a range of different document types, an attractive layout can make the difference between a reader stopping and reading the document or throwing it away.

The production of attractive documents is a skilled task and can be quite time consuming. The author has recognised that there is a need for systems and solutions for the production of documents which de-skill the author/designer of the document. To achieve this, a set of tests and quantitative measurements must be provided which enable the system to select an attractive solution from a set of alternatives, or simply analyse a document that has already been produced by an un-skilled author or automatic system and provide the author with feedback on the quality of the document layout.

Symmetry and in particular visual symmetry is one of the most fundamental principles in a design of a document. By symmetry we mean that the position and size of objects on one side of an axis of a page or a part of a page are duplicated exactly on the other side of the axis. The objects do not need to have the same content—one could be text and the other graphics for example. Visual symmetry doe not require exact duplication across the axis, as the human eye could not detect a small deviation. The axis may be a horizontal or a vertical axis passing through a centre point of a page or part of a page of the document and for a typical printed document such as a page of text these objects may be text and/or graphics and/or images contained within rectangular boundary boxes.

The choice between symmetry and asymmetry affects the layout and feeling of a page. A symmetrical layout of objects gives a feeling of permanence and stability to the page. Any symmetrical document content is likely to be more static and restful: it is used to advantage in advertisements emphasising quality, and by businesses whose position in community rests on trust. Only visual symmetry is required for publishing, as a human eye cannot detect a small deviation.

An object of the present invention is to provide a method and system for providing an estimate or a measure of the degree of symmetry in a page or a part of a page of a document.

According to a first aspect the invention provides a method for estimating the symmetry present in a page or a part of a page of a document comprising:
defining a set of co-ordinates of features of the content of the document using a co-ordinate system, one axis of which is aligned with an axes about which the symmetry is to be estimated and the other orthogonal to this;
mapping the co-ordinates into complex co-ordinates in a complex plane;
and determining how far the content is from the nearest symmetrical layout.

The step of determining how far it is from the nearest symmetrical layout comprises determining a measure of symmetry for the set of co-ordinates indicative of how far the mapped co-ordinates are from being complex conjugate pairs.

By estimate of symmetry we may mean an estimate value V indicative of how far the page layout is from symmetrical about the specified axis, or perhaps how close it is to symmetrical about that axis. We may provide more than one estimate value, each corresponding to symmetry about a different axis.

It has been appreciated that if a page or a part of a page of a document is perfectly symmetrical about an axis then all the complex co-ordinates in the set of complex co-ordinates can be matched up to form complex conjugate pairs.

The estimate value V may be a distance value D which may vary over a range of values with one extreme end of the range corresponding to total symmetry in the document content about the chosen axis and the other extreme no symmetry about the axis. It may, for example, be zero valued in the case of perfect symmetry about the axis.

In some cases the method may include the step of fitting the page or part of the page of the document to a pair of orthogonal x-y co-ordinate axes, the x axis lying along the axis about which symmetry is to be estimated and forming a data set of co-ordinates for predetermined features of objects located on the page.

This step may not be required if the document content is already defined in terms of a set of co-ordinate axes.

It may also include a step of transforming each of the pairs of x-y co-ordinates in the set of x-y co-ordinates defining features of the content of the page into a complex co-ordinate in which the x co-ordinate forms the real part of a complex number and the y co-ordinate forms the imaginary part.

The method may construct a set of co-ordinates which correspond to features of the content in many ways. For example, if all the objects are circles of the same diameter only the coordinates of the centres are needed.

In another example, when used with pages that contain non-overlapping rectangular boundary boxes containing text or graphics or a combination of both it is sufficient that the features may comprise the corners of any boxes present in the document. In this case, the total number k of co-ordinates in the set of x-y co-ordinates will comprise four times the number of boxes—one for each corner of all of the objects.

In a still further example, where objects may overlap one another the features may comprise both the corners and the centres of the boxes.

Many different methods may be used to determine the distance measure D indicating how far a page or a part of a page of a document is from the nearest symmetrical case. In the simplest, D is set at zero for a visually symmetrical case and one at all other times. A more useful measure would be a value of D that increases the farther from symmetrical a page or part of a page of a document becomes.

Determining a distance in the complex space is computationally very difficult as the space is not linear. The method may therefore include a step of mapping the coordinates for the layout into an alternative space and also mapping the symmetrical solutions into this new space and determining the distance of the layout from the nearest symmetrical layout in this alternative space. The alternative space may be chosen such that the problem of determining distance is linear.

The method of the present invention may therefore, in at least one preferred arrangement, determine an estimate of symmetry by finding the polynomial with unit leading coefficient which has n complex roots equal to the n complex coordinates of the content of a document containing n objects and determining the distance from a point defined by the coefficients of that polynomial in the space of complex polynomials to the real linear subspace of real polynomials.

If the distance is zero the page or part of the page of the document is perfectly symmetrical. As the distance increases, so the document becomes less symmetrical.

In other words, to determine the distance from the space of real polynomials to our polynomial, the method may include a step of calculating the coefficients aⱼ of a polynomial of degree n, where n is the number of complex co-ordinates in the set, which has a unit leading coefficient and which has the set of co-ordinates as roots. The method may then include the step of determining how close the set of complex co-ordinates are to forming a set of complex conjugate pairs by analysing the values of the coefficients.

The coefficients aⱼ will be real if and only if the set of co-ordinates comprises only complex conjugate pairs and points on the real axis. Accordingly, the measure of symmetry may indicate total symmetry in the event that all of the coefficients of the polynomial are real values. The measure of symmetry may indicate to what extent the coefficients of the polynomial are not purely real.

The polynomial may be expressed as:

$${P}_{n} ( z ) = {\prod }_{j = 1}^{n} ( z - ( {x}_{j} + {Iy}_{j} ) ) = {\sum }_{j = 0}^{n} {a}_{j} {z}^{j}$$

where aₙ=1 and aⱼ are given by the Vieta formulas:

$${a}_{n - m} = {( - 1 )}^{m} \cdot {\sum }_{0 < {j}_{1} < {j}_{2} < … < {j}_{m} \leq n} {z}_{{j}_{1}} \cdot {z}_{{j}_{2}} \cdot … \cdot {z}_{{j}_{m}}$$

where m=1 . . . n

The method may calculate D by calculating the size of the imaginary parts of the coefficients of the polynomial. The method may produce a value D for the estimate of symmetry from the equation:

$$D = \sqrt{{\sum }_{j = 0}^{n - 1} {( Im {a}_{j} )}^{2}}$$

Of course, other techniques could be used to determine a value of D, such as summing the absolute value of the imaginary parts of the coefficients.

In an alternative, a different distance value D* may be calculated by selecting n different real numbers and calculating the value of the polynomial for these n points and then calculating the size of the imaginary components of the value of the polynomial for these points. The n points may be selected randomly. If all the coefficients of the polynomial were real all the points would also be real. Hence, D* may be calculated as the square root of the sum of the square of the imaginary parts of a number of points on the polynomial, typically:

$${D}^{*} = \sqrt{{\sum }_{j = 0}^{n} {( Im ( {P}_{n} ( j ) ) )}^{2}}$$

where Pₙ is as defined above. This value of D* will behave similarly to D.

The method may be used for the post verification of the symmetry in a design of a page, perhaps for selecting a preferred layout based on the estimate of the symmetry from a number of alternatives.

The method may include a step of accessing the page from an electronic memory such as a hard drive or compact disc or the like and passing the accessed document to a processor which performs the steps of processing the document to produce the complex co-ordinate set before subsequently producing the estimate of symmetry and writing it back to an area of memory or a display.

The method may be performed across a digital network. The digital network may comprise any network such as an intranet or perhaps the world wide web.

According to a second aspect the invention provides a system for estimating the symmetry present in a page or a part of a page of a document comprising:
a complex co-ordinate set generator which determines a set of complex co-ordinates for features of the content of the document, one axis of which is aligned with the axis about which the estimate of symmetry is to be made;
a mapping function which maps the co-ordinates onto complex co-ordinates; and
an estimator which provides an estimate of the degree of symmetry which is dependent upon how close the co-ordinates in the set of complex co-ordinates are to forming complex conjugate pairs.

The system may include a co-ordinate generator which receives data defining a document and fits the data to a set of orthogonal x-y co-ordinates, the x axis lying along the axis about which symmetry is to be estimated and the mapping function may be arranged to receive the co-ordinate data produced by the co-ordinate generator and transform each of the co-ordinates in the set of co-ordinates into a complex co-ordinate in which the x co-ordinate forms the real part of a complex number and the y co-ordinate forms the imaginary part.

The system may include one or more areas of memory in which the document data and the co-ordinates/transformed co-ordinates are stored. The document or a copy of the document may be stored electronically within the memory.

The system may include input means, such as a keyboard or mouse, by which a user can define the location relative to the document of the axis about which symmetry is to be estimated.

It may also include a display on which the estimate of symmetry may be displayed to a user. The display may also present to the user an image of the document that has been analysed.

According to a third aspect the invention provides a computer program for estimating the symmetry present in a document which comprises a set of program instructions which when running on a processor cause the processor to:
determine a data set of complex co-ordinates for predetermined features of objects located in the document, the real axis of which is aligned with the axis about which symmetry is to be determined; and
provide an estimate of the degree of symmetry which is dependent upon how close the co-ordinates in the set of complex co-ordinates are to the nearest symmetrical set of co-ordinates.

The program may cause the processor to fit the document to a pair of orthogonal x-y co-ordinate axes, the x axis lying along the axis about which symmetry is to be estimated and subsequently to transform the x-y co-ordinates into a set of co-ordinates in the complex plane.

The document may be stored as electronic data in a memory which can be accessed by the processor and in an initial step the computer program may be adapted to cause the processor to retrieve the document from the memory for processing of the data. The program may also cause the processor to store the co-ordinate data and the transformed co-ordinates in a memory. This may be a different area of the same memory in which the document data is stored.

The computer program may cause the processor to output the estimate of the degree of symmetry, or a value or other indicia derived therefrom to a display which is connected to the processor.

The computer program may be adapted to prompt a user of the processor to input at least one document for processing. After an estimate of its symmetry has been output to the display (where provided) it may cause the processor to prompt a user to alter the document or provide an alternative document.

The computer program may prompt a user to select an axis about which symmetry is to be estimated. The user may be permitted to select more than one axis, such as horizontal axis, vertical axis and centre for radial symmetry.

The computer program may comprise at least a part of a document-publishing suite which permits a user to create one or documents prior to analysing the documents for symmetry.

There will now be described, by way of example only, one embodiment of the present invention with reference to the accompanying drawings of which:

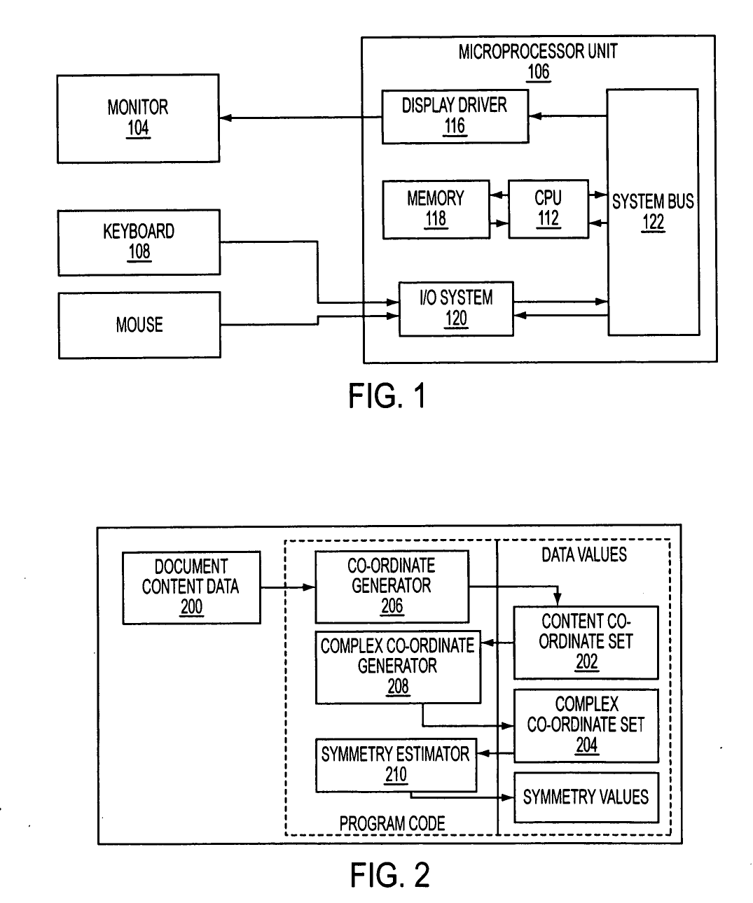

FIG. 1 is an overview of a computer system which is in accordance with a second aspect of the invention;

FIG. 2 is a block diagram illustrating the arrangement of data within the memory of the system of FIG. 1;

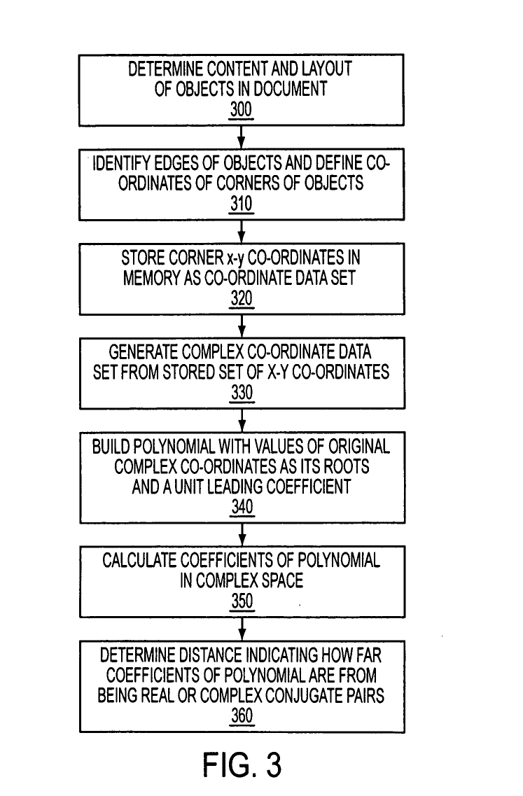

FIG. 3 is a block diagram of the steps performed by the system of FIG. 1 when executing the program blocks stored in the memory;

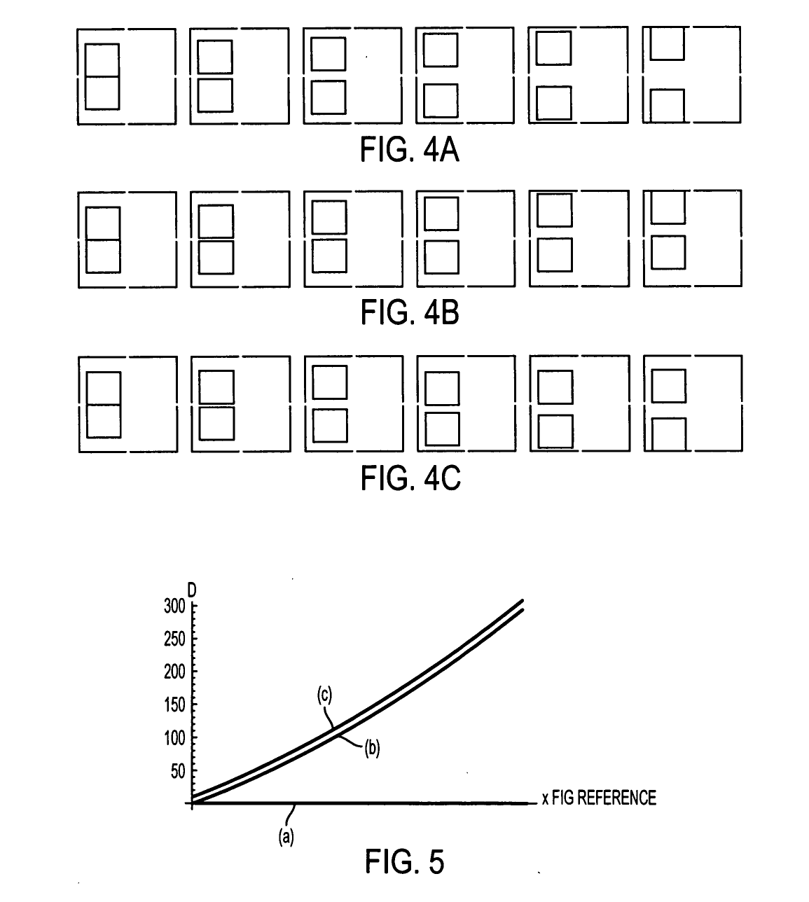

FIG. 4(a) shows a set of otherwise identical documents containing two box-like objects which move apart symmetrically in the vertical axis;

FIG. 4 (b) shows a set of otherwise identical documents containing two box-like objects which move apart asymmetrically in the vertical axis

FIG. 4(c) shows a set of otherwise identical documents containing two box-like objects which move apart asymmetrically in the vertical axis as a mirror image of the set of documents in FIG. 4(b);

FIG. 5 is a plot of the changes in the value of D output by the system illustrated in FIGS. 1 to 3 of the accompanying drawings for the documents shown in FIGS. 4(a) to (c);

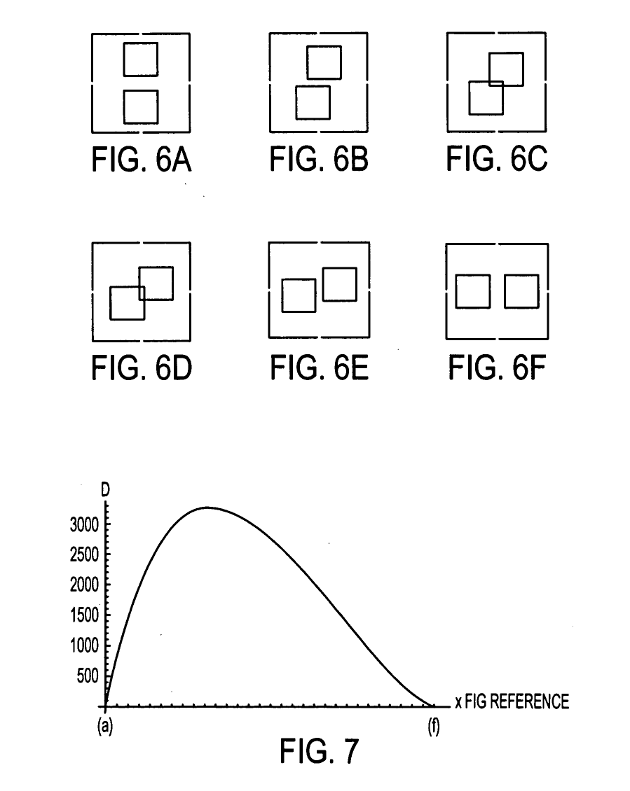

FIGS. 6(a) to (f) show a set of otherwise identical documents in which the two objects in a document move from a symmetrical through a non-symmetrical and back to a symmetrical state;

FIG. 7 is a plot of the changes in the value of D output by the system illustrated in FIGS. 1 to 3 of the accompanying drawings for the documents shown in FIGS. 6(a) to (f);

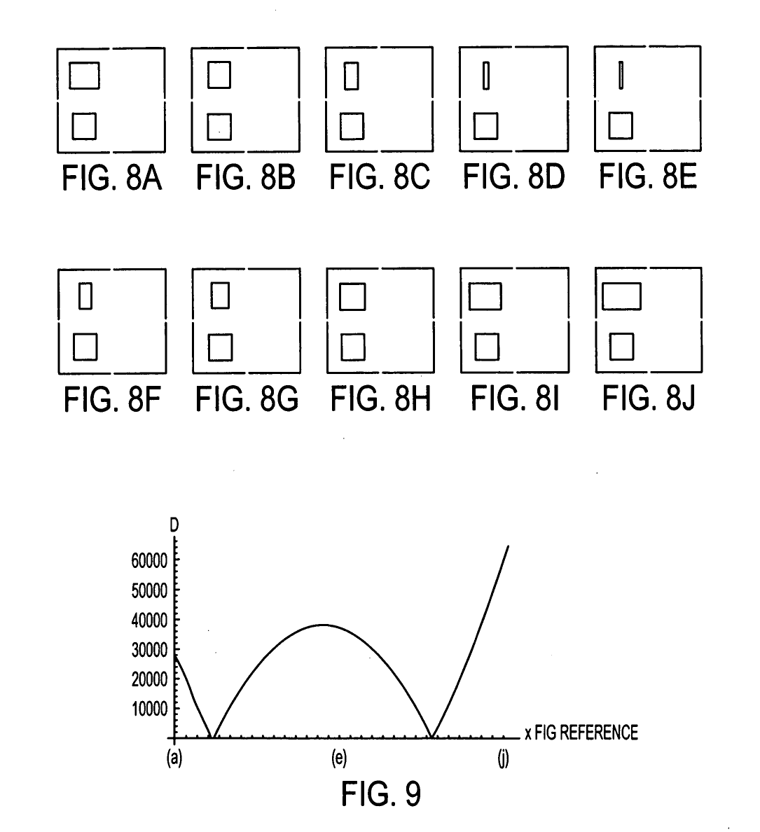

FIGS. 8(a) to (j) shows a set of otherwise identical documents containing two box-like objects which move apart from an initial asymmetric state through a symmetrical state and back to an asymmetric state;

FIG. 9 is a plot of the changes in the value of D output by the system illustrated in FIGS. 1 to 3 of the accompanying drawings for the documents shown in FIGS. 8(a) to (j);

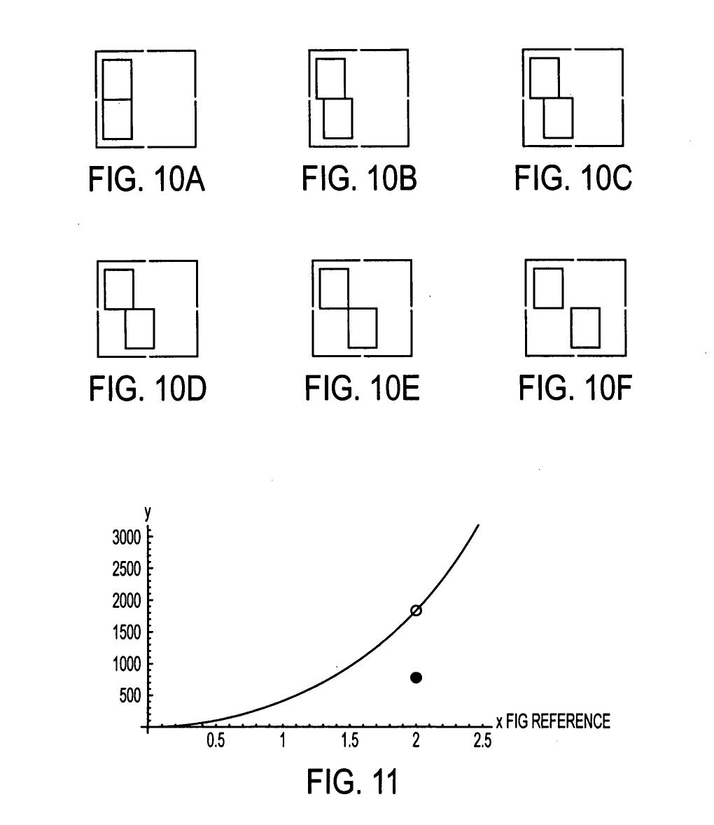

FIG. 10 shows a set of otherwise identical documents containing two box-like objects which share common points and which move apart from an initial symmetric state;

FIG. 11 is a plot of the changes in the value of D output by the system illustrated in FIGS. 1 to 3 of the accompanying drawings for the documents shown in FIGS. 8(a) to (j); and

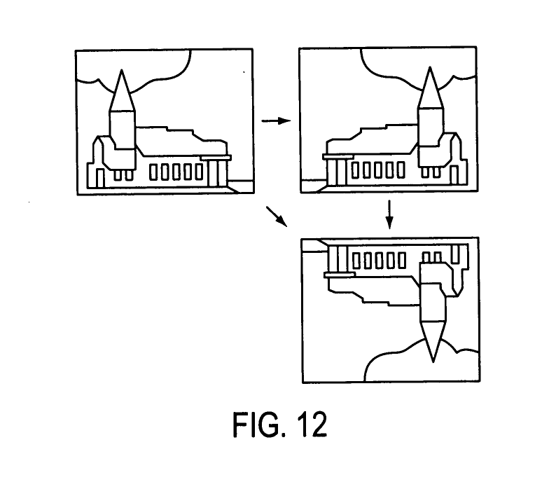

FIG. 12 illustrates the way in which the exemplary system reduces a radial problem to a composition of both horizontal and vertical transformations.

This particular invention is applicable to analyse a page or part of a page of a document to produce an estimate of the symmetry present in a document. Generally the document to be analysed will be stored in an electronic format in an electronic memory. It can be created electronically, for example using a proprietary publishing package or word processor. Alternatively, it may be a paper document which is converted into an electronic format using a suitable image capture apparatus. Typical examples of such apparatus are based on flat bed scanners or desk mounted digital cameras—both of which are well known in the art.

Although not limited to any particular applications, it is envisaged that the invention will have particular application to the field of automatically generated documents. The production of documents is a time consuming task which is made more time consuming if the documents are to be customised to a reader. The first step is to determine what the document is to contain. The document may, for example, be a holiday brochure which is customised so as to contain information which matches the interests of the reader. In this case, a set of customised content is generated for that user from a global set of content. The content items are a selection of viewable or printable two-dimensional elements relating to holidays: these may be pictures or text descriptions. Each content item may be tagged with a description indicating their relevance to a particular keyword. The significance of the keywords for the intended reader is determined by direct polling of the recipient, perhaps by analysing the recipients previous holidays or by studying information that the recipient has previously read.

Once a group of content is selected it is next fitted to the document. For a multi-page document it is subdivided into content for each page, or perhaps for sub-regions of a single page of the document.

In the next step, the content is fitted to the document. This can be performed manually or automatically. In the case of a manual fitting, the designer will consciously or subconsciously follow rules for fitting such as ensuring that a degree of symmetry is present or absent. With an automatic system, such rules may be applied but may conflict with other rules such as the requirement for the system to simply fit the content in the most efficient manner. It is this later case that the present invention is especially suitable for, although it will find application in the case of manually designed document in that it enables the results of the fitting to be quantified.

Multiple attempts to assess symmetry have been made in the past. For example, a recent attempt is known from Evaluating interface Aesthetics, knowledge and Information systems 4: pp46-79 authored by Ngo DCL, Byrne JG, 2002. However, their measure of symmetry provides only a necessary condition for symmetry which is equal to zero for both a symmetrical case and also some asymmetrical cases. Hence it cannot be used as a reliable test as it can in some cases produce false results. For example, having a small measure for this test the system cannot possibly decide on whether the considered layout is close to a symmetrical case or a “false” symmetrical case.

In many instances it will be impossible to find a perfectly symmetrical layout. In any event, there is a difference between perfect symmetry in a mathematical sense and symmetry as judged by the human eye. For a document to appear symmetrical it needs only to possess visual symmetry. Due to a limited resolution of the eye, a document which is not perfectly symmetrical will appear to have visual symmetry to the reader. A measure which can indicate not only if a document is symmetrical but also how far it is from symmetrical would therefore be of great benefit. The present invention, in at least one preferred arrangement, provides a method for determining such as measure.

In the example described hereinafter a system for the automatic creation of a page or a part of a page of a document is described with reference to FIG. 1 of the accompanying drawings.

The system 100 comprises a processing means in the form of a microprocessor unit 106 connected to peripheral devices including a display means such as a monitor 104 and input devices which in this example comprise a keyboard 108 and a mouse 110. More specifically the microprocessor unit 106 further comprises a housing for a central processing unit (CPU) 112, a display driver 116, memory 118 (RAM and ROM) and an I/O subsystem 120 which all communicate with one another, as is known in the art, via a system bus 122. The processing unit 112 comprises an INTEL PENTIUM series processor, running at typically between 900 MHZ and 1.7 GHZ.

As is known in the art the ROM portion of the memory 118 contains the Basic Input Output System (BIOS) that controls basic hardware functionality. The RAM portion of memory 118 is a volatile memory used to hold instructions that are being executed, such as program code, etc.

The apparatus 100 could have the architecture known as a PC, originally based in the IBM specification, but could equally have other architectures. The server may be an APPLE, or may be a RISC system, and may run a variety of operating systems (perhaps HP-UX, LINUX, UNIX, MICROSOFT NT, AIX or the like).

As shown in FIG. 2 of the accompanying drawings, document content data 200 defining the content of a document to be analysed and its layout is held on the server 100 in a portion of the memory. The document is entered into the computer by capturing an image of the document using a scanner. Alternatively, the document may be created in an electronic format using a suitable authoring tool running on the processor. The system prompts a user to provide a document if a suitable document is not already available in the memory.

A computer program comprising a set of program instructions is also stored in the memory which when running instructs the computer to process the data 200 defining the content to determine the amount of symmetry present. The input devices permit the user to control the operation of the program and hence the computer. This allows the user to indicate whether the document is to be analysed for vertical symmetry, horizontal symmetry, radial symmetry or any combination of the three.

The computer program comprises several blocks of data, each of which when executed by the processor cause the processor to perform various functions in manipulating the document content data stored in the memory. During the manipulation intermediate data is produced, including a content co-ordinate set 202 and a complex co-ordinate data set 204 which are also stored at least temporarily within the memory. These program blocks and the data can be seen in the block diagram of FIG. 2 of the accompanying drawings and can be summarised as a co-ordinate set generator block 206, a complex co-ordinate set generator block 208 and an estimator block 210. Of course, the reader will readily appreciate the description of blocks of data in the memory is purely conceptual and that in practice the program may be stored as many fragments of data distributed across portions of the memory.

Lets first assume that a document has been designed with content items fitted to the page. For convenience, consider that each content item can be encapsulated by a two dimensional rectangular shaped boundary box and that all the shapes are fitted onto a single document of A4 size. A standard x-y co-ordinate frame may be applied to the page, with the origin lying at the centre of the page or portion of the page.

The sequence of operational steps performed by the system when executing the blocks of program data stored in the memory can best be understood by reference to the flow chart of FIG. 3. This sets out the method steps performed by the system in analysing a page first for horizontal and then for vertical and radial symmetry.

In a first step 300, the content and layout of a document is determined and a set of co-ordinate axes are defined for the content of the document under test. As discussed, the x- co-ordinate may be aligned with a horizontal axis of the page and the y-axis aligned with a vertical axis of the page. The origin of the axes is chosen to co-incide with the centre of the page. In some cases, the data defining the content and layout of a page may already be defined in terms of a suitable co-ordinate scheme and so this step may be omitted.

In the next step 310, the vertices of objects on the document are identified using an appropriate edge detection routine. The co-ordinates of the corners of these vertices are then stored 320 in a memory. (In an alternative where the objects are not rectangular the co-ordinates of the centre and other feature points of the objects may be identified instead). Let the stored co-ordinates be expressed as
S={{x₁,y₁}, . . . {xₖ,yₖ}}
where n is the number of co-ordinates which will be equal to four times the number of objects.

To identify axial symmetry the problem is reduced to identifying symmetry with respect to the x-axis. To do so the method next maps 330 all of the co-ordinates in the set onto the complex plane to provide a new set as given by:
S={x₁+Iy₁, . . . , xₙ+Iyₙ}

In the next steps the method determines the symmetry about the real axis in this newly defined complex plane. Our problem is now to give a measure of symmetry of the set of co-ordinates S with respect to the real axis in the complex plane.

Remembering that the complex conjugate of a complex number z=x+Iy is defined by z=x−Iy, this means that a pair of co-ordinates that form a complex conjugate pair are symmetrical with respect to the real axis. Therefore, if all of the co-ordinates for the set of identified vertices and centres can be paired up to form a set of complex conjugate pairs then the objects on the page are completely symmetrical. So, symmetry of S with respect to the real axis means that S is a set of real numbers and complex conjugate numbers only.

Let us identify all possible sets of co-ordinates S with a subset of the n-dimensional complex space. Next let us denote the set of all symmetric configurations within that n-dimensional complex space by Symₙ. Since Symₙ is not a linear space, the problem of finding the distance from a set of co-ordinates Z defining the content of a document from Symₙ is difficult.

To overcome this difficulty, we have found another representation of the complex space and the set of symmetric solutions Symₙ in which the problem becomes linear. This representation is based around the Fundamental Theorem of Algebra which says that a polynomial of degree n with complex coefficients (which includes real coefficients as a special case of course) has exactly n complex roots counting multiplicities. Using this theorem one can introduce a one to one correspondence between the complex space and the space of complex polynomials of order n with unit leading coefficient.

One of the fundamental results of the theorem is that the polynomial with unit leading coefficient (aₙ=1) has real or complex conjugate roots if and only if all the coefficients are real. This means that the space of all real polynomials in the space of all possible complex polynomials can be mapped in a one-to-one way to the subset Symₙ in the complex space. We therefore now only need to find the distance from an arbitrary polynomial to the real linear subspace of real polynomials. This forms a suitable measure of symmetry.

The method therefore determines symmetry by determining whether all the complex co-ordinates form complex conjugate pairs. To do so the next step 340 of the method is to build a polynomial with points from set S as its roots and a unit leading coefficient. This can be constructed using the formula:

$${P}_{n} ( z ) = {\prod }_{j = 1}^{n} ( z - ( {x}_{j} + {Iy}_{j} ) ) = {\sum }_{j = 0}^{n} {a}_{j} {z}^{j}$$

where aₖ=1 and aⱼ are given by the Vieta formulas:

$${a}_{n - m} = {( - 1 )}^{m} \cdot {\sum }_{0 < {j}_{1} < {j}_{2} < … < {j}_{m} \leq n} {z}_{{j}_{1}} \cdot {z}_{{j}_{2}} \cdot … \cdot {z}_{{j}_{m}}$$

As stated, using this theorem the constructed polynomial will have real coefficients if and only if all the roots form complex conjugate pairs.

Subsequently, the method analyses 350 the coefficients of the constructed polynomial and determines 360 how far the coefficients are from being real. A heuristical threshold level may be set which is considered to be equivalent to the threshold level of visual symmetry set by the eye of the reader, and anything that falls below this threshold may be considered to be acceptable as a visually symmetrical layout.

If all the coefficients of the polynomial are real the layout is completely symmetrical. To estimate how far it is from symmetrical the Euclidian distance can be calculated from the following expression:

$${D}^{*} = \sqrt{{\sum }_{j = 0}^{n} {( Im ( {P}_{n} ( j ) ) )}^{2}}$$

Situations that are perfectly symmetrical produce a value of D equal to zero, and the value of D increases the further away from symmetrical it gets. As the distance is Euclidian, the value of D will change monotonically as the document gets further away from symmetrical.

Of course, other expressions could be employed to derive a value indicating how far the imaginary parts of the coefficients deviate from the ideal zero values. A suitable equivalent distance within the space can be determined by selecting n different real value points and calculating the value of the polynomial Pₙ(j) from those points. If all the coefficients of the polynomial are real the value of the polynomial for each of the n point will also be real. A distance D* can be calculated from the expression:

$${D}^{*} = \sqrt{{\sum }_{j = 0}^{n} {( Im ( {P}_{n} ( j ) ) )}^{2}}$$

Either expression can be used although the later is preferred as it can be evaluated in fewer computational steps and scales as O(n²)

Having calculated the symmetry about the vertical axis, the method steps may be repeated with some variation to determine the symmetry about the horizontal axis and also radial symmetry. For symmetry about the horizontal axis the method steps can be repeated in the same way except that the x and y axes must be reversed when calculating the co-ordinates of the objects.

For radial symmetry, the page is transformed into a new page by dividing the page in half horizontally (or vertically) about its centre and flipping only one half of the divided page about the horizontal axis and also about the vertical axis as shown in FIG. 12 of the accompanying drawings to perform a new image. The steps of the method are then performed on the new image to determine correspondent vertical or horizontal symmetry. If the document possessed radial symmetry the horizontal and vertical tests would produce zero values.

To better illustrate how the invention works consider the example illustrated in FIGS. 4(a) to 4(c) and of the accompanying drawings.

The first intuitive assumption that can be drawn about the objects shown in this FIG. 4 is that identical (subject to symmetry) movements should result in identical changes of the value D. Working across the top row corresponding to FIG. 4 (a) shows a set of otherwise identical documents containing two box-like objects which move apart in the vertical axis. No break in horizontal symmetry occurs over this sequence of documents. The traces shown in FIG. 5 illustrate how the value of D for horizontal symmetry varies across the documents. As expected, no change in D can be seen and it remains zero valued.

Consider instead the documents shown in the middle row corresponding to FIG. 4(b). Working across from the left to the right the symmetry is clearly driven farther from the original symmetrical state (farthest left). Again the trace in FIG. 5 illustrates how the value of D varies and it does indeed increase as expected.

Next consider the documents shown the bottom row corresponding to FIG. 4(c). The changes in the content of these documents working from left to right mirror those made in FIG. 4(b). Again, this shows up as an increase in D which is identical to that seen for FIG. 4(b) as expected.

A further test is illustrated in FIGS. 6(a) to (f) in which the objects in a document move from a symmetrical through a non-symmetrical and back to a symmetrical state. As shown in FIG. 7 of the accompanying drawings when these documents are analysed using the system given as an example in FIGS. 1 and 2 this change is accurately reflected in the value of D for each document.

A still further example is given in FIGS. 8(a) to 8(j) of the accompanying drawings. In this example one of the two boxes initially shrinks in size before expanding again. As shown in FIG. 9, which is a plot of D for each of FIGS. 8(ea) to (j) the function D perfectly mirrors the situation. It starts from a non-symmetrical state in FIG. 8(a) and eventually reaches the first symmetrical position at FIG. 8(e).Then it moves away from zero until the upper box vanishes whereafter the whole cycle is repeated.

There may be cases where objects such as boxes share one or more points in common. An example of this is shown in FIG. 10(a) and FIG. 10(b) for two similar layouts of boxes. In this case, each overlapping point should be taken into account separately for each object so that the value of D complies with our intuition that the symmetry of cases A and B should result in close values. Passing such examples through the system shown in FIGS. 1 to 3 has indeed been shown to provide intuitive results as illustrated in FIG. 11.

The described system can also effectively handle radial symmetry as well as both horizontal and vertical symmetry. This is achieved by reducing a radial problem to a composition of both horizontal and vertical transformations (applied in any order) as shown in FIG. 12 of the accompanying drawings.

1. A method for estimating the symmetry present in a page or part of a page of a document comprising:
defining a set of co-ordinates of features of the content of the document using a co-ordinate system, one axis of which is aligned with an axes about which the symmetry is to be estimated and the other orthogonal to this;
mapping the co-ordinates into complex co-ordinates in a complex plane;
and determining how far the content is from the nearest symmetrical layout.

2. The method of claim 1 in which the estimate of symmetry comprises an estimate value V indicative of how far the document content is from symmetrical about at least one axis.

3. The method of claim 2 in which more than one estimate value is provided, each corresponding to symmetry about a respective axis.

4. The method of claim 1 which includes the step of fitting the page to a pair of orthogonal x-y co-ordinates axes, the y axis lying along the axis about which symmetry is to be estimated and forming a data set of co-ordinates for predetermined features of objects located in the page, and transforming each of the co-ordinates in the set of x-y co-ordinates defining features of the content of the document into a complex co-ordinate in which the x co-ordinate forms the real part of a complex number and the y co-ordinate forms the imaginary part.

5. The method of claim 1 in which the features used to define the co-ordinates comprise the corners of any rectangular objects present in the page.

6. The method of claim 1 which includes a step of determining an estimate of symmetry by finding the polynomial with unit leading coefficient which has n complex roots equal to the n complex co-ordinates of the content of a page or a part of a page containing n items.

7. The method of claim 6 in which the distance is determined by determining the distance from a point defined by the coefficients of that polynomial in the space of complex polynomials to the real linear subspace of real polynomials.

8. The method of claim 6 in which the distance is determined by selecting n different real values and finding the value of the polynomial at these n points, and further by calculating the size of the imaginary components of the value of the polynomial at these n points.

9. A system for estimating the symmetry present in a page or a part of a page of a document comprising:
a complex co-ordinate set generator which determines a set of complex co-ordinates for features of the content of the document, one axis of which is aligned with the axis about which the estimate of symmetry is to be made;
a mapping function which maps the co-ordinates onto complex co-ordinates; and
an estimator which provides an estimate of the degree of symmetry which is dependent upon how close the co-ordinates in the set of complex co-ordinates are to forming complex conjugate pairs.

10. The system of claim 9 which includes a co-ordinate generator which receives data defining a document and fits the data to a set of orthogonal x-y co-ordinates, the y axis lying along the axis about which symmetry is to be estimated and the complex co-ordinate set generator is arranged to receive the co-ordinate data produced by the co-ordinate generator and transform each of the co-ordinates in the set of co-ordinates into a complex co-ordinate in which the x co-ordinate forms the real part of a complex number and the y co-ordinate forms the imaginary part.

11. The system of claim 9 which includes one or more areas of memory in which the document data and the co-ordinates/transformed co-ordinates are stored

12. The system of claim 9 which includes input means, such as a keyboard or mouse, by which a user can define the location relative to the document of the axis about which symmetry is to be estimated and a display on which the estimate of symmetry is displayed to a user.

13. A computer program for estimating the symmetry present in a page or a part of a page of a document which comprises a set of program instructions which when running on a processor cause the processor to:
determine a data set of complex co-ordinates for predetermined features of objects located in the document, the real axis of which is aligned with the axis about which symmetry is to be determined; and
provide an estimate of the degree of symmetry which is dependent upon how close the co-ordinates in the set of complex co-ordinates are to the nearest symmetrical set of co-ordinates.

14. The computer program of claim 13 which causes the processor to fit the document to a pair of orthogonal x-y co-ordinate axes, the y axis lying along the axis about which symmetry is to be estimated and subsequently to transform the x-y co-ordinates into a set of co-ordinates in the complex plane.

15. The computer program of claim 13 in which the document is stored as electronic data in a memory which can be accessed by the processor and in an initial step the computer program is adapted to cause the processor to retrieve the document from the memory for processing of the data.

16. A computer program implementing the method of claim 1.
